(19) United States
(12) Patent Application Publication
(10) Pub. No.: US 2010/0143615 A1
(43) Pub. Date: Jun. 10, 2010

(54) Ink-jet printable film simultaneously having hot-melt and ink-receiving properties

(76) Inventor: Tsang I Hsu, Chiali (TW)

Correspondence Address: Hsu, Tsang I, P.O. Box 55-846, Taipei, 104, TW

(21) Appl. No.: 12/315,917

(22) Filed: Dec. 9, 2008

(51) Int. Cl. B41M 5/00

(52) U.S. Cl. 428/32.1

(57) ABSTRACT

An ink-jet printable film comprises a hot-melt and ink-receiving layer coated on a transparent protective layer, which is coated on a releasing layer, whereby the hot-melt and ink-receiving layer, formed as a micro-porous film, may well absorb the ink as jetted from a printer for producing image with high resolution and may be firmly adhered to a fabric or leather object to be printed.

### BACKGROUND OF THE INVENTION

U.S. Pat. No. 6,638,604 disclosed an ink jet transfer system comprising a carrier material, a hot-melt layer being applied onto the carrier material and plural ink-receiving layers applied onto the hot-melt layer.

However, such a prior art has the following drawbacks:
1. There are two steps required to apply a dispersion containing the ink-receiving layer onto the hot-melt layer, namely, in the first step a thickness of 15 μm and in a second step a thickness of 10 μm is applied, whereby a total thickness of the ink-receiving layer of 25 μm is achieved. The two steps for applying two ink-receiving layers onto the hot-melt layer may increase the production complexity and cost.
2. After the ink-jet transfer system is used to print a graphic presentation on a T-shirt, a normal white paper is required to apply onto said print (on T-shirt) and is again pressed for about 10 seconds at a temperature about 190° C. in order to achieve a better washability and complete respiratory activity, thereby causing the difficulty and inconvenience of its use for transfer printing.

The present inventor has found the drawbacks of the prior art and invented the present ink-jet printable film to overcome the defects of the prior art.

### SUMMARY OF THE INVENTION

The object of the present invention is to provide an ink-jet printable film comprising a hot-melt and ink-receiving layer coated on a transparent protective layer, which is coated on a releasing layer, whereby the hot-melt and ink-receiving layer, formed as a micro-porous film, may well absorb the ink as jetted from a printer for producing image with high resolution and may be firmly adhered to the object to be printed.

### BRIEF DESCRIPTION OF THE DRAWINGS

FIG. 1 is a cross sectional drawing showing the multiple layers of the present invention.

FIG. 2 is a cross sectional drawing showing the film of the present invention as adhered on a fabric or leather object for transfer printing.

### DETAILED DESCRIPTION

The ink-jet printable film of the present invention comprises: a hot-melt and ink-receiving layer 1; a transparent protective layer 2; and a releasing layer 3 laminated to form the multiple-layer film in accordance with the present invention.

The releasing layer 3 may be a releasing paper made of paper pulp, or a plastic thin layer such as polypropylene (PP) or poly ethylene terephthalate (PET) film. The releasing layer 3 is releasably removed from the protective layer 2.

The transparent protective layer 2 may be made of polyurethane, which may be formed or coated on the releasing layer 3 to be a transparent thin film for protecting the printed pattern or graphic presentation on a fabric or leather object. Such a protective layer 2 made of polyurethane may be extended to be a film through a T-die of an extruder (not shown) to be applied on the releasing layer 3 or by coating a liquid polyurethane on the releasing layer 3, which is then dried, cooled and wound up.

The hot-melt and ink-receiving layer 1 is coated or formed on the transparent protective layer 2 by a process which will be described hereinafter.

A paste of the hot-melt and ink-receiving layer 1 is pre-formed before being coated on the transparent protective layer 2. Such a paste composition (100% by weight) comprises the following ingredients:
1. Thermoplastic polyurethane, having a softening point of 60˜150° C.----10˜30 (weight) %;
2. Organic solvent, having a boiling point ranging from 70˜165° C., e.g., aliphatic, aromatic alcohol or the other organic solvents----50˜80 (weight) %;
3. Foaming agent, e.g., Dinitroso Pentamethylene Tetramine (DPT), with a foaming or reaction temperature of 100˜120° C.----0.01˜0.5 (weight) %; and
4. Ink-absorptive porous filler, e.g. silica, having particle size of 10˜400 microns----3˜20 (weight) %.

The paste composition as above-mentioned is homogeneously mixed under high-speed agitation, e.g. 100˜1200 rpm, for 30˜180 minutes to form a fluid paste, which is then applied or coated on the protective layer 2 which is pre-wound as aforementioned.

The multiple-layer film, composed of the hot-melt and ink-receiving layer 1, the protective layer 2 and the releasing layer 3, is finally dried (at 60˜150° C. for 3˜10 minutes), cooled and wound up to be the film product of the present invention.

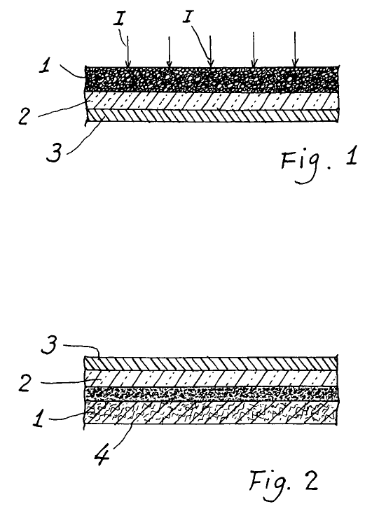

The ink-jet printable film of the present invention thus obtained is provided for practical printing of a pattern, image or graphic feature on an object such as a fabric or leather object with the following steps:
1. A digital ink-jet printer is provided to print a mirror image (or to print in a reverse-side way) on the hot-melt and ink-receiving layer 1 of the film as shown in FIG. 1, in which numeral “I” indicates the ink-jet direction from the printer towards the hot-melt and ink-receiving layer 1.
2. By reversing the printable film from FIG. 1 to FIG. 2 to overlay the hot-melt and ink-receiving layer 1 on the object 4 to be printed as shown in FIG. 2 and to face the releasing layer 3 upwardly ready for completing the thermal transfer printing.
3. A heat pressure (such as by ironing) is applied onto the printable film at 90˜180° C. under pressure 1˜5 kg/cm² for 3˜90 seconds (which however may be further adjusted or varied according to practical printing conditions or requirements) to firmly fix the image or pattern on the fabric or leather object 4.
4. The film product is cooled and the releasing layer 3 is then removed to complete the transfer printing of the present invention.

The present invention discloses an essential novel element, namely, the hot-melt and ink-receiving layer 1, which plays a double-role duty both for hot-melt property and ink-receiving property merely by a single layer, other than two or plural layers, thereby eliminating the complex repeated coating of plural layers of ink-receiving layers as required by the prior art and thereby greatly simplifying the production procedures and reducing the production cost.

The paste composition for forming the hot-melt and ink-receiving layer 1 of the present invention has the ingredients thereof rendering the following advantages:
1. The foaming agent will produce micro pores, open cells or micro cellular structure in the printable film for well absorbing the ink.
2. The organic solvent, after being evaporated during drying step, will produce porous structure for helping absorbing ink. So, the solubility of the PU polymer in the solvent may be adjusted to be beneficial for forming the microporosity in the film after vaporizing the solvent out of the film.
3. The ink-absorptive porous filler (such as silica) will itself serve as a strong absorbent for well absorbing the ink.

So, the micorporosity, tunnels, gaps as rendered by the hot-melt and ink-receiving layer 1 will efficiently absorb the ink as jetted from the printer or plotter.

The ink thus absorbed will be penetrated into the micro pores in the “bottom” of the layer 1. In other words, the ink spots of the printed image will be stably “encapsulated” or “locked” within the layer 1 of the printable film for better color fixation and clear vision of the printed image or pattern.

The hot-melt and ink-receiving layer 1 is majorly made of thermoplastic polyurethane having excellent hot tacky property for serving a better hot-melt adhesive for firmly bonding the printable film on the object to be printed.

The polyurethane of the present invention forms a continuation phase, while the filler (e.g. silica) forms the dispersion phase, both being non-conflicting in the present invention by a critical control of the filler (silica) concentration in the paste composition of the hot-melt and ink-receiving layer 1 such as to be less than 30% (by weight) of filler content in the paste composition.

Even the filler is a discontinuous dispersion phase, the low-content (less then 30%) filler can still be even spread or dispersed in the continuous phase of polyurethane, thereby capable for forming a homogeneous hot-melt adhesive layer in the interface between the layer 1 of the printable film of this invention and the fabric or leather object 4 for providing a satisfactory bonding property therebetween.

The hot-melt and ink-receiving layer 1 is thermally compressed to form a dense layer from FIG. 1 to FIG. 2 to thereby “encapsulate” the ink spots of the printed image into the deep “bottom” portion of the film to furnish a better printing quality.

By aid of the protective layer 2, the printed image on the fabric or leather object 4 will be better resistant to abrasion, water wash, and will have a good flexibility, toughness and anti-bending property.

The microporosity of the hot-melt and ink-receiving layer 1 will absorb and penetrate the jetting ink deeply into the film to enhance high resolution of the image, pattern or graphic feature thus printed, to prevent the unduly spreading of the ink spots. The ink residue remained on the top surface of the film will be greatly minimized, which, in turn, will help render the hot tacky property of the polyurethane.

Therefore, the present invention can provide a high resolution printing image as well as strong bonding strength between the film and the printed fabric or leather object to be superior to the conventional ink jet print or transfer systems.

The present invention may be further modified without departing from the spirit and scope of the present invention.

In some situations, the transparent protective layer 2 may also be eliminated so that the hot-melt and ink-receiving layer 1 may be directly coated on the releasing layer (or paper) 3 to further simplify the production for cost reason or for the related industrial or commercial reasons.

I claim:

1. An ink-jet printable film comprising:
a hot-melt and ink-receiving layer made of a paste composition containing thermoplastic polyurethane as a major ingredient and having microporosity formed in said layer for well absorbing ink and penetrating ink deeply into a bottom of said layer for forming high resolution of a printing image;
a transparent protective layer having said hot-melt and ink-receiving layer coated or formed on said transparent protective layer; and
a releasing layer having said transparent protective layer releasably coated on said releasing layer.

2. A film according to claim 1, wherein said transparent protective layer is made of polyurethane.

3. A film according to claim 1, wherein said releasing layer includes: a releasing paper, and a plastic thin film including polypropylene and polyethylene terephthalate.

4. A film according to claim 1, wherein said paste composition of said hot-melt and ink-receiving layer comprises the following ingredients based on 100% by weight of the paste composition:
A. Thermoplastic polyurethane---10˜30 (weight) %;
B. Organic solvent-----------------50˜80 (weight) %;
C. Foaming agent----------------0.01˜0.5 (weight) %; and
D. Ink-absorptive porous filler----3˜20 (weight) %.

5. A film according to claim 4, wherein said ink-absorptive porous filler is silica.

6. A film according to claim 4, wherein said paste composition is homogeneously mixed to form a liquid paste, said liquid paste being applied or coated on a transparent protective layer, which is pre-coated on a releasing layer.

7. An ink-jet printable film comprising:
a hot-melt and ink-receiving layer made of a paste composition and having microporosity formed in said layer for well absorbing ink and penetrating ink deeply into a bottom of said layer for forming high resolution of a printing image; and
a releasing layer releasably adhered to said hot-melt and ink-receiving layer;
said paste composition of said hot-melt and ink-receiving layer comprising the following ingredients based on 100% by weight of the paste composition:
A. Thermoplastic polyurethane----10˜30 (weight) %;
B. Organic solvent-----------------50˜80 (weight) %;
C. Foaming agent------------------0.01˜0.5 (weight) %; and
D. Ink-absorptive porous filler----3˜20 (weight) %;
said paste composition homogeneously mixed to form a liquid paste, and said liquid paste applied or coated on said releasing layer.

8. A film according to claim 7, wherein said ink-absorptive porous filler is silica.
